(19) United States
(12) Patent Application Publication
(10) Pub. No.: US 2010/0053739 A1
(43) Pub. Date: Mar. 4, 2010

(54) Laser device providing an adjusted field distribution for laser beams thereof

(75) Inventors: An-Chi Wei, Chu-Nan (TW); Wen-Jang Jiang, Chunan-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan City (TW)

(21) Appl. No.: 12/583,976

(22) Filed: Aug. 28, 2009

(30) Foreign Application Priority Data
Aug. 29, 2008 (CN) 200810304292.2

(51) Int. Cl. G02B 17/08; G02B 3/06

(52) U.S. Cl. 359/365; 359/710

(57) ABSTRACT

An exemplary laser device includes a laser source and an optical module. The laser source is configured for emitting a laser beam in the TEM_{xy} mode, wherein 0≦x≦3, and 0≦y≦3. The optical module includes a cylindrical-type lens disposed on a light path of the laser beam. The cylindrical-type lens has a first surface and an opposite second surface, and the first surface faces toward the laser source. At least one of the first surface and the second surface is a cylindrical-type curved surface configuring for adjusting a field distribution of the laser beam of the laser source.

### BACKGROUND

1. Technical Field

The present disclosure relates to laser devices, and particularly, to a laser device configured to provide an adjusted field distribution for its laser beams.

2. Description of Related Art

Conventional techniques for cutting glass use either of two main methods. The first of these methods requires mechanical scribing of the glass along a desired cutting line, and subsequent breaking of the glass along the scribe line. The second method is a state of the art method, which requires inducing a shallow crack along a desired cutting line on the glass using a laser beam, and then breaking the glass along this crack. The first laser cutting method is less expensive, but produces powder debris during the scribing step. A large market utilizing glass cutting is flat panel display manufacturing, which is intolerant of the generation of debris. Thus, the second laser cutting method is more suitable for this market. The field distribution of the laser beam is a key parameter that controls the quality of cutting of a glass panel. Precise field distribution of the laser beam is a significant challenge for the further improvement of the cutting speed and efficiency of the laser cutting method.

What is needed, therefore, is a laser device with good field distribution of the laser beam.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, all the views are schematic, and like reference numerals designate corresponding parts throughout the several views.

FIG. 1 is a top plan view of a laser device of a first embodiment, showing certain essential optical paths of a laser beam thereof.

FIG. 2 is an isometric view of a laser device of a second embodiment, showing certain essential optical paths of a laser beam thereof.

FIG. 3 is a top plan view of a laser device of a third embodiment, with a first optical lens adjacent to a focal plane and a second optical lens adjacent to a laser source of the laser device, showing certain essential optical paths of a laser beam of the laser source.

FIG. 4 is a top plan view of a laser device of a variation of the third embodiment, with the first optical lens adjacent to the laser source and the second optical lens adjacent to the focal plane, showing certain essential optical paths of a laser beam of the laser source.

FIG. 5 is a reproduction of a photograph of a light area formed on the focal plane by the laser device of FIG. 4.

FIG. 6 is a reproduction of a photograph of the laser beam emitted from the laser source of FIG. 4 when the laser beam is in the TEM₁₀ (Transverse Electromagnetic) mode.

FIG. 7 is a reproduction of a photograph of a light area formed on the focal plane by the laser device of FIG. 4 when the laser beam of the laser source is in the TEM₁₀ mode.

FIG. 8 is an isometric view of a laser device of a fourth embodiment, showing certain essential optical paths of a laser beam of a laser source thereof.

FIG. 9 is a reproduction of a photograph of the laser beam emitted from the laser source of FIG. 8 when the laser beam is in the TEM₀₁ mode.

FIG. 10 is a reproduction of a photograph of two light areas formed on a focal plane by the laser device of FIG. 8 when the laser beam is in the TEM₀₁ mode.

FIG. 11 is a top plan view of a laser device of a fifth embodiment, with two reflective elements positioned between a laser source and an optical lens of the laser device, showing certain essential optical paths of a laser beam of the laser device.

FIG. 12 is a top plan view of a laser device of a variation of the fifth embodiment, with the reflective elements positioned between the optical lens and a focal plane, showing certain essential optical paths of a laser beam of the laser source.

### DETAILED DESCRIPTION OF EMBODIMENTS

Embodiments of the present laser device will now be described in detail below and with reference to the drawings.

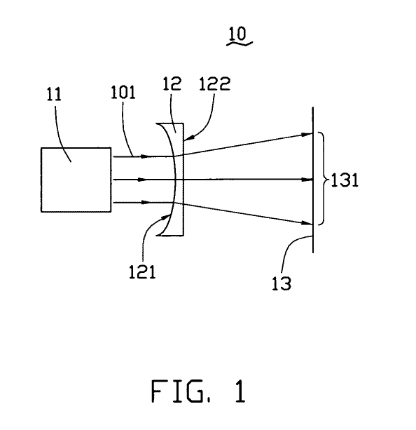

Referring to FIG. 1, a first embodiment of a laser device 10 is provided. The laser device 10 includes a laser source 11 and an optical module 12.

The laser source 11 is configured for emitting a laser beam 101 in the TEM_{xy} (Transverse Electromagnetic) mode, wherein 0≦x≦3, and 0≦y≦3. In the present embodiment, a transverse cross-section of the laser beam 101 emitting from the laser source 11 is generally circular, with x=0 and y=0. That is, the laser beam 101 is in the TEM₀₀ mode.

The optical module 12 includes a single cylindrical lens, which is disposed on a light path of the laser beam 101. The single cylindrical lens is arranged between the laser source 11 and a focal plane 13. In the illustrated embodiment, the cylindrical lens is a plano-concave cylindrical lens. In particular, the optical module 12 has a first surface 121 and a second surface 122 at opposite sides thereof. The first surface 121 is a generally cylindrical concave surface, which faces toward the laser source 11. The second surface 122 is a flat surface, which faces toward the focal plane 13. The circular laser beam 101 passes through and is diverged (spread) by the optical module 12. The diverged laser beam 101 strikes the focal plane 13 to form a light area 131 thereon. Due to the configuration of the cylindrical concave surface 121, the plano-concave cylindrical lens enables the laser beam 101 passing therethrough to spread in a range of directions corresponding to a predetermined desired axis. In particular, the laser beam 101 spreads generally away from a central transverse (vertical) plane of the optical module 12 toward two peripheries of the optical module 12 which are at two opposite lateral sides of the central transverse plane. As a result, a transverse diameter of the laser beam 101 is expanded after the laser beam 101 passes through the optical module 12, and the expanded light area 131 is formed. That is, the light area 131 formed on the focal plane 13 is asymmetric, and is typically in the shape of an elongated ellipse. Thus, a field distribution of the laser beam 101 of the laser source 11 is adjusted. In addition, the optical module 12 only includes a single plano-concave cylindrical lens; thus the laser device 10 has a simple structure and low cost.

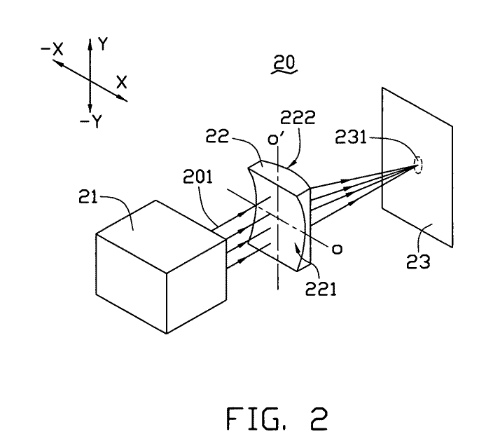

Referring to FIG. 2, a second embodiment of a laser device 20 is provided. The laser device 20 includes a laser source 21 and an optical module 22.

The laser source 21 is configured for emitting a laser beam 201 in the TEM_{xy} mode, wherein 0≦x≦3, and 0≦y≦3. In the present embodiment, a transverse cross-section of the laser beam 201 emitted from the laser source 21 is generally circular, with x=0 and y=0.

The optical module 22 includes a single cylindrical-type lens, which is disposed on a light path of the laser beam 201 between the laser source 21 and a focal plane 23. In the illustrated embodiment, the cylindrical-type lens is a concavo-convex cylindrical lens. In particular, the optical module 22 has a first surface 221 and a second surface 222 at opposite sides thereof. The first surface 221 is a cylindrical concave surface, which faces toward the laser source 21. The cylindrical concave surface subtends a first imaginary axis O of the concavo-convex cylindrical lens, the first imaginary axis O being parallel with an X-axis, as shown in FIG. 2. The second surface 222 is a cylindrical convex surface, which faces toward the focal plane 23. The cylindrical convex surface can be considered to subtend a second imaginary axis O′ of the concavo-convex cylindrical lens, the second imaginary axis O′ being parallel with a Y-axis, as shown in FIG. 2. The X-axis is perpendicular to the Y-axis, and the first imaginary axis O is perpendicular to the second imaginary axis O′.

Due to the configuration of the cylindrical concave surface 221 and the cylindrical convex surface 222, the concavo-convex cylindrical lens enables the laser beam 201 passing therethrough to diverge in a range of directions corresponding to the Y-axis and to converge in a range of directions corresponding to the X-axis.

In particular, operation of the optical module 22 is described below with reference to certain exemplary essential optical paths of the laser beam 201. In FIG. 2, four exemplary essential optical paths of the laser beam 201 between the laser source 21 and the optical module 22 are shown. These four essential optical paths all lie in a same vertical plane that is parallel to the Y-axis. Light traveling along each of the four essential optical paths is diverged by the cylindrical concave surface 221 in a range of directions all of which lie in the same vertical plane that is parallel to the Y-axis. In FIG. 2, four exemplary essential optical paths of the laser beam 201 (different from the above-mentioned four exemplary essential optical paths) between the optical module 22 and the focal plane 23 are shown. These four essential optical paths all lie in a same horizontal plane that is parallel to the X-axis. Light traveling along each of the four essential optical paths is converged light that has been converged by the cylindrical convex surface 222 in a range of directions all of which lie in the same horizontal plane that is parallel to the X-axis. In FIG. 2, the light of the four essential optical paths substantially converges to a spot (not labeled) on the focal plane 23.

As a result of the laser beam 201 passing through the cylindrical concave surface 221 and the cylindrical convex surface 222, a transverse diameter of the laser beam 201 along the Y-axis is expanded and a transverse diameter of the laser beam 201 along the X-axis is compressed, and a light area 231 is formed on the focal plane 23. The light area 231 is asymmetric, and is typically in the shape of an elongated ellipse. Thus, a field distribution of the laser beam 201 of the laser source 21 is adjusted.

It can be understood that in alternative embodiments, each of the first surface 221 and the second surface 222 may be a flat surface, a spherical surface, or another kind of curved surface, so long as at least one of the first surface 221 and the second surface 222 is a cylindrical-type curved surface to adjust the field distribution of the laser beam 201 of the laser source 21.

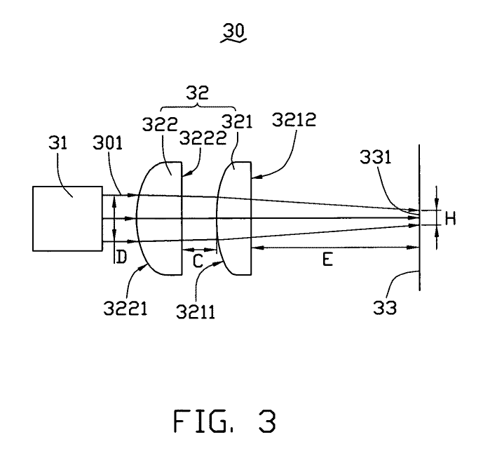

Referring to FIG. 3, a third embodiment of a laser device 30 is provided. The laser device 30 includes a laser source 31 and an optical module 32.

The laser source 31 is configured for emitting a laser beam 301 in the TEM_{xy} mode, wherein 0≦x≦3, and 0≦y≦3. In the present embodiment, a transverse cross-section of the laser beam 301 emitted from the laser source 31 is generally circular, with x=0 and y=0.

The optical module 32 includes a first optical lens 321 and a second optical lens 322, which are arranged between the laser source 31 and a focal plane 33. The first optical lens 321 is a cylindrical-type lens, which is disposed on a light path of a laser beam 301 and is generally adjacent to the focal plane 33. In particular, the first optical lens 321 is a plano-convex cylindrical lens, which has a first surface 3211 and a second surface 3212 at opposite sides thereof. The first surface 3211 is a cylindrical convex surface, which faces toward the second optical lens 322. The second surface 3212 is a flat surface, which faces toward the focal plane 33. The second optical lens 322 is a spherical lens, which is disposed on the light path of the laser beam 301 and is generally adjacent to the laser source 31. The second optical lens 322 has a third surface 3221 and a fourth surface 3222 at opposite sides thereof. The third surface 3221 is a spherical surface, which faces toward the laser source 31. The fourth surface 3222 is a flat surface, which faces toward the first optical lens 321.

Due to the configuration of the spherical surface 3221, a laser beam 301 passing therethrough converges. That is, the circular transverse cross-section of the laser beam 301 is reduced in size. Due to the configuration of the cylindrical convex surface 3211, the laser beam 301 passing therethrough converges in a range of directions corresponding to a predetermined desired axis. In particular, the laser beam 301 converges generally from two peripheries of the first optical lens 321 which are at two opposite lateral sides of the first optical lens 321 to a central transverse (vertical) plane of the first optical lens 321.

As a result of the laser beam 301 passing through the spherical surface 3221 and the cylindrical convex surface 3211, a transverse diameter of the laser beam 301 is compressed after the laser beam 301 passes through the optical module 32, and a light area 331 is formed on the focal plane 33. The light area 331 is asymmetric, and is typically in the shape of an elongated ellipse. Thus, a field distribution of the laser beam 301 of the laser source 31 is adjusted.

It can be understood that in alternative embodiments, each of the first surface 3211, the second surface 3212, the third surface 3221, and the fourth surface 3222 may be a flat surface, a spherical surface, or another kind of curved surface, so long as at least one of the first surface 3211 and the second surface 3212 is a cylindrical-type curved surface, and at least one of the third surface 3221 and the fourth surface 3222 is a nonplanar surface, to adjust the field distribution of the laser beam 301 of the laser source 31.

In the present embodiment, an adjusted field distribution of the laser beam 301 of the laser source 31 can be formed on the focal plane 33 by changing the structure of any one or more of the first, second, third, and fourth surfaces 3211, 3212, 3221, 3222, and/or a distance between the first optical lens 321 and the second optical lens 322.

The following parameters are defined in respect of the laser device 30. A diameter of the laser beam 301 is equal to D, a distance between the first optical lens 321 and the second optical lens 322 is equal to C, and a distance between the first optical lens 321 and the focal plane 33 is equal to E. A width of the horizontal axis (short axis) of the light area 331 is equal to H, and a width of a vertical axis (long axis) of the light area 331 is equal to V (not shown in FIG. 3, being perpendicular to the page). An effective focal length of the second optical lens 322 is equal to f1, and an effective focal length of the first optical lens 321 is equal to f2. These parameters satisfy the following equations:

f1=D(C+E)/(D−h) (1)

f2=E(DE+hC)/((h−v)(C+E)) (2)

wherein v=V when the focal plane 33 is located at a position before a meridional focus, and in reverse, v=−V; and h=H when the focal plane 33 is located at a position before a sagittal focus, and in reverse, h=−H.

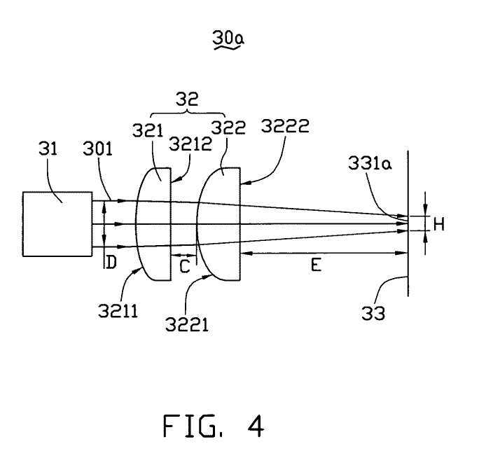

In addition, in a variation of the third embodiment, the first optical lens 321 can be arranged generally adjacent to the laser source 31, and the second optical lens 322 can be arranged between the first optical lens 321 and the focal plane 33, as shown in FIG. 4. With this configuration, a laser device 30a is formed. The laser device 30a produces a light area 331a. The light area 331a is asymmetric, and is typically in the shape of an elongated ellipse. The following parameters are defined in respect of the laser device 30a. A distance between the second optical lens 322 and the focal plane 33 is equal to E, a diameter of the laser beam 301 is equal to D, and a distance between the first optical lens 321 and the second optical lens 322 is equal to C. A width of a horizontal axis (short axis) of a light area 331a is equal to H, and a width of a vertical axis (long axis) of the light area 331a is equal to V (not shown in FIG. 4, being perpendicular to the page). An effective focal length of the first optical lens 321 is equal to f1, and an effective focal length of the second optical lens 322 is equal to f2. These parameters satisfy the following equations:

f1=(hC+DE)/(h−v) (3)

f2=DE/(D−h) (4)

wherein, v=V when the focal plane 33 is located at a position before a meridional focus, and in reverse, v=−V; and h=H when the focal plane 33 is located at a position before a sagittal focus, and in reverse, h=−H.

Characteristics of the laser device 30a in accordance with the variation of the third embodiment will now be described. In one example, the laser beam 301 is in the TEM₀₀ mode, and has a wavelength of 10.6 micrometers (μm) and a diameter of 11.5 millimeters (mm). The laser beam 301 passes through the first optical lens 321 and the second optical lens 322, and the elliptical light area 331a is formed on the focal plane 33. The distance C between the first optical lens 321 and the second optical lens 322 and the distance E between the second optical lens 322 and the focal plane 33 are assumed to be 50 mm and 177 mm, respectively. In order that the width V of the long axis of the elliptical light area 331a is greater than 60 mm and the width H of the short axis of the elliptical light area 331a is less than 3 mm, using equations (3) and (4), one can derive the f₁ and f₂ needed for the design of the two optical lenses 321, 322, and then calculate the corresponding radiuses of curvature needed for the curved surfaces 3211, 3221 of the optical lenses 321, 322.

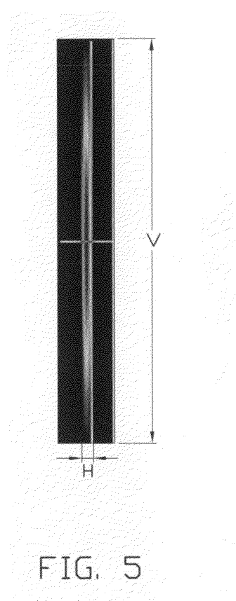

In the present example, the following values are assumed: V=68 mm, and H=2 mm. The first optical lens 321 is the cylindrical-type lens having the cylindrical convex surface 3211, and the second optical lens 322 is the spherical lens having the spherical surface 3221. According to the calculation (details of which are omitted for the sake of brevity), a curvature radius of the cylindrical convex surface 3211 is equal to 42 mm, and a curvature radius of the spherical surface 3221 is equal to 300 mm. A reproduction of a photograph of the light area 331a formed on the focal plane 33 is shown in FIG. 5.

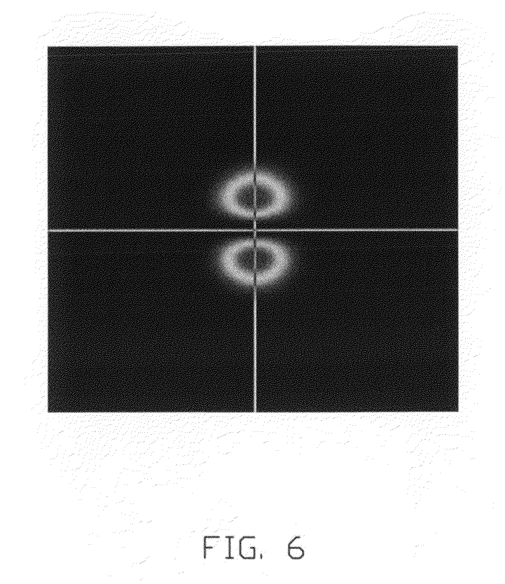

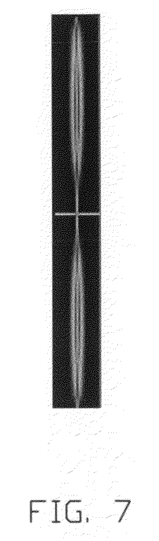

Referring to FIG. 6, in another example, the laser beam 301 of the laser device 30a is in the TEM₁₀ mode. In this mode, the intensity distribution of the laser beam 301 consists essentially of two separate spots, one above the other. After the laser beam has passed through the optical module 32, a pair of corresponding elliptical light areas is formed on the focal plane 33, as shown in FIG. 7.

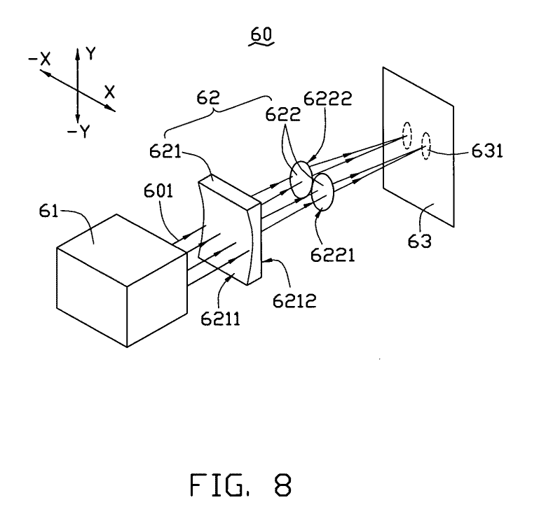

Referring to FIG. 8, a fourth embodiment of a laser device 60 is provided. The laser device 60 includes a laser source 61 and an optical module 62.

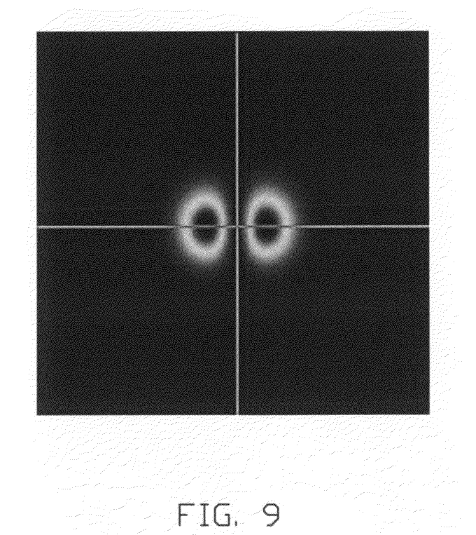

The laser source 61 is configured for emitting a laser beam 601 in the TEM_{xy} mode, wherein 0≦x≦3, and 0≦y≦3. In the present embodiment, the laser source 61 is configured to emit the laser beam 601 in the TEM₀₁ mode. In this mode, the intensity distribution of the laser beam 601 consists essentially of two separate spots side by side, as shown in FIG. 9.

The optical module 62 includes a first optical lens 621 and a second optical lens 622, which are arranged between the laser source 61 and a focal plane 63. The first optical lens 621 is a cylindrical-type lens, which is disposed on a light path of the laser beams 601 and is generally adjacent to the laser source 61. In particular, the first optical lens 621 is a plano-concave cylindrical lens, which has a first surface 6211 and a second surface 6212 at opposite sides thereof. The first surface 6211 is a generally cylindrical concave surface, which faces toward the laser source 61. The second surface 6212 is a flat surface, which faces toward the second optical lens 622. The second optical lens 622 is a free-form lens, which is disposed on the light path of the laser beams 601 and is generally adjacent to the focal plane 63. The second optical lens 622 has two separate focal points located on a same imaginary plane transverse to the light path of the laser beams 601. Preferably, such plane coincides with the focal plane 63. The second optical lens 622 has a third surface 6221 and a fourth surface 6222 at opposite sides thereof. The third surface 6221 is a free-form convex surface, which faces toward the first optical lens 621. The fourth surface 6222 is a flat surface, which faces toward the focal plane 63.

Due to the configuration of the cylindrical concave surface 6211, the laser beam 601 passing therethrough is spread in a range of directions corresponding to a predetermined desired axis. In particular, the laser beam 601 spreads generally away from a central transverse (horizontal) plane of the first optical lens 621 toward two peripheries of the first optical lens 621 which are at two opposite lateral sides of the central transverse plane. The diverged laser beam 601 enters the second optical lens 622 and is converged by the free-form convex surface 6221 in a range of directions perpendicular to the predetermined desired axis.

In particular, operation of the optical module 62 is described below with reference to certain exemplary essential optical paths of the laser beam 601. In FIG. 8, four exemplary essential optical paths of the laser beam 601 between the laser source 61 and the optical module 62 are shown. These four essential optical paths all lie in a same horizontal plane. Light traveling along each of the four essential optical paths is diverged by the cylindrical concave surface 6211 in a range of directions all of which lie in the same vertical plane. In FIG. 8, four exemplary essential optical paths of the laser beam 601 (different from the above-mentioned four exemplary essential optical paths) between the first optical lens 621 and the second optical lens 622 are shown. These four essential optical paths all lie in a same horizontal plane. Light traveling along each of the four essential optical paths is converged by the free-form convex surface 6221 in a range of directions all of which lie in the same horizontal plane. In FIG. 8, light traveling along two of the four essential optical paths substantially converges to a spot (not labeled) on the focal plane 63, and light traveling along the other two essential optical paths substantially converges to another spot (not labeled) on the focal plane 63.

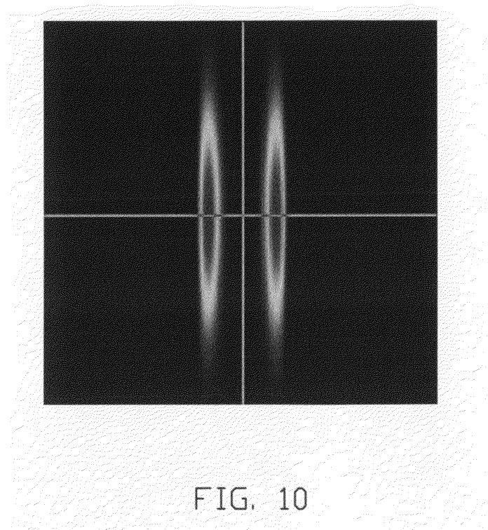

As a result of the TEM₀₁ mode laser beam 601 passing through the cylindrical concave surface 6211 and the free-form convex surface 6221, a transverse diameter of each of the two separate portions of the laser beam 601 along a Y-axis is expanded, and a transverse diameter of each separate portion of the laser beam 601 along an X-axis is compressed, and two light areas 631 are formed on the focal plane 63. Each light area 631 is asymmetric, and is typically in the shape of an elongated ellipse. Thus, a field distribution of the laser beam 601 of the laser source 61 is adjusted. A reproduction of a photograph of the two light areas 631 formed on the focal plane 63 is shown in FIG. 10.

It can be understood that in alternative embodiments, each of the first surface 6211, the second surface 6212, the third surface 6221, and the fourth surface 6222 may be a flat surface, a spherical surface, or another kind of curved surface, so long as at least one of the first surface 6211 and the second surface 6212 is a cylindrical-type curved surface, and at least one of the third surface 6221 and the fourth surface 6222 is a non-planar surface, to adjust the field distribution of the laser beam 601 of the laser source 61.

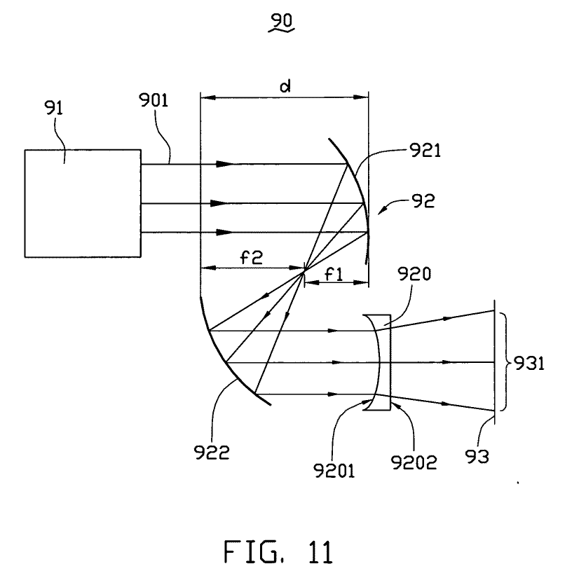

Referring to FIG. 11, a fifth embodiment of a laser device 90 is provided. The laser device 90 includes a laser source 91 and an optical module 92.

The laser source 91 is configured for emitting a laser beam 901 in the TEM_{xy} mode, wherein, 0≦x≦3 and 0≦y≦3. In the present embodiment, a transverse cross-section of the laser beam 901 emitted from the laser source 91 is generally circular, with x=0 and y=0.

The optical module 92 includes an optical lens 920, a first reflective element 921, and a second reflective element 922. The optical lens 920 is a cylindrical-type lens, which is disposed on a light path of a laser beam 901 and is generally adjacent to a focal plane 93. In the illustrated embodiment, the cylindrical-type lens is a plano-concave cylindrical lens. In particular, the optical lens 920 has a first surface 9201 and a second surface 9202 at opposite sides thereof. The first surface 9201 is a generally cylindrical concave surface, which faces toward the second reflective element 922. The second surface 9202 is a flat surface, which faces toward the focal plane 93. The first reflective element 921 and the second reflective element 922 are disposed on the light path of the laser beam 901, between the laser source 91 and the first surface 9201. The first reflective element 921 receives light from the laser source 91. The reflective elements 921, 922 may be ellipsoid mirrors or paraboloid mirrors.

A distance d is defined as a horizontal distance along an axis that is parallel to a path of the laser beam 901 emitting from the laser source 91. In particular, the distance d spans from a point corresponding to an apex of the reflective element 921 which is farthest from the reflective element 922 to a point corresponding to an apex of the reflective element 922 which is farthest from the reflective element 921. A focal length of the first reflective element 921 is equal to f₁, and a focal length of the second reflective element 922 is equal to f₂. The focal length f₁, the focal length f₂ and the distance d satisfy the equation:

|f₁|+|f₂|=d

wherein a diameter of the laser beam 901 can be modulated by the reflective elements 921, 922, such that the laser beam 901 remains as a parallel beam when it reaches the optical lens 920. The plano-concave lens 920 enables the laser beam 901 passing therethrough to spread in a range of directions corresponding to a predetermined desired axis. In particular, the laser beam 901 spreads generally away from a central transverse (vertical) plane of the optical lens 920 toward two peripheries of the optical lens 920 which are at two opposite lateral sides of the optical lens 920. As a result, a transverse diameter of the laser beam 901 is expanded after the laser beam 901 passes through the optical lens 920, and an expanded light area 931 is formed. That is, the light area 931 formed on the focal plane 93 is asymmetric, and is typically in the shape of an elongated ellipse. Thus, a field distribution of the laser beam 901 of the laser source 91 is adjusted.

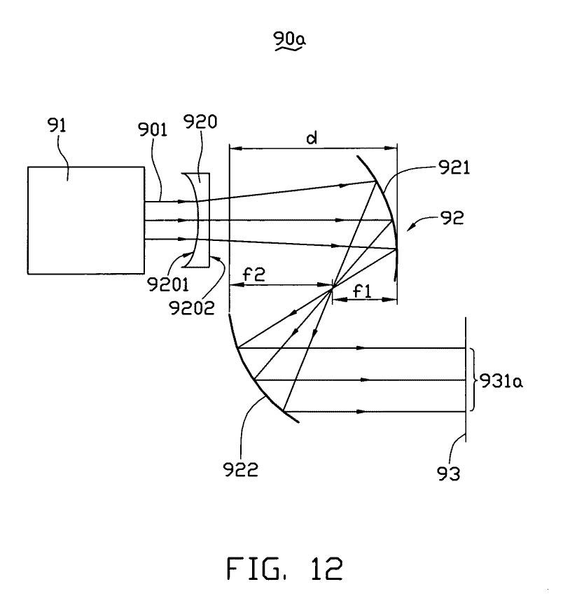

It can be understood that in alternative embodiments, the optical lens 920 can be arranged generally adjacent to the laser source 91, and the reflective elements 921, 922 can be disposed on the light path of the laser beam 901 between the optical lens 920 and the focal plane 93, as shown in FIG. 12. With this configuration, a laser device 90a is formed. In such case, the plano-concave lens 920 enables the laser beam 901 passing therethrough to spread generally away from a central transverse (vertical) plane of the optical lens 920 toward two peripheries of the optical lens 920 which are at two opposite lateral sides of the optical lens 920, and the modulated laser beam is then reflected by the reflective elements 921, 922, such that a light area 931a is produced on the focal plane 93. The light area 931a is asymmetric, and is typically in the shape of an elongated ellipse. Thus, a field distribution of the laser source 91 is adjusted. The focal length f₁, the focal length f₂ and the distance d satisfy the equation:

|f₁|+|f₂|=d

In other alternative embodiments, each of the first surface 9201 and the second surface 9202 of the optical lens 920 may be a flat surface, a spherical surface, or another kind of curved surface, so long as at least one of the surfaces 9201, 9202 is a cylindrical-type curved surface to adjust the field distribution of the laser beam 901 of the laser source 91.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A laser device comprising:
a laser source configured for emitting a laser beam in the TEM_{xy} mode, wherein 0≦x≦3, and 0≦y≦3; and
an optical module comprising a cylindrical-type lens disposed on a light path of the laser beam, the cylindrical-type lens comprising a first surface and a second surface at opposite sides thereof, the first surface facing toward the laser source, at least one of the first surface and the second surface being a cylindrical-type curved surface for adjusting a field distribution of the laser beam of the laser source.

2. The laser device of claim 1, wherein the cylindrical-type curved surface is a cylindrical convex surface.

3. The laser device of claim 1, wherein the cylindrical-type curved surface is a cylindrical concave surface.

4. The laser device of claim 1, wherein the optical module further comprises a second optical element disposed on the light path of the laser beam between the laser source and the cylindrical-type lens, the second optical element comprises a third surface and a fourth surface at opposite sides thereof, the third surface faces toward the laser source, and at least one of the third surface and the fourth surface is a nonplanar surface.

5. The laser device of claim 4, wherein at least one of the third surface and the fourth surface is selected from the group consisting of a spherical surface, a cylindrical concave surface, and a cylindrical convex surface.

6. The laser device of claim 1, wherein the optical module further comprises a second optical element disposed on the light path of the laser beam at a side of the cylindrical-type lens farthest from the laser source, the second optical element comprises a third surface and a fourth surface at opposite sides thereof, the third surface is adjacent to the cylindrical-type lens, and at least one of the third surface and the fourth surface is a nonplanar surface.

7. The laser device of claim 6, wherein at least one of the third surface and the fourth surface is selected from the group consisting of a spherical surface, a cylindrical concave surface, and a cylindrical convex surface.

8. The laser device of claim 6, wherein the second optical element defines two separate focal points on a same imaginary transverse plane that is perpendicular to the light path of the laser beam.

9. The laser device of claim 1, wherein the optical module further comprises a first curved reflecting element and a second curved reflecting element both disposed between the laser source and the cylindrical-type lens, and a focal length f₁ of the first reflective element and a focal length f₂ of the second reflective element satisfy the equation:

|f₁|+|f₂|=d
wherein d represents a distance measured parallel to the light path of the laser beam from the laser source, and d spans from a point corresponding to an apex of the first reflective element which is farthest from the second reflective element to a point corresponding to an apex of the second reflective element which is farthest from the first reflective element.

10. The laser device of claim 9, wherein each of the first reflecting element and the second reflecting element is selected from the group consisting of an ellipsoid mirror and a paraboloid mirror.

11. The laser device of claim 1, wherein the optical module further comprises a first curved reflecting element and a second curved reflecting element both disposed on the light path of the laser beam at a side of the cylindrical-type lens farthest from the laser source, and a focal length f₁ of the first reflective element and a focal length f₂ of the second reflective element satisfy the equation:

|f₁|+|f₂|=d
wherein d represents a distance measured parallel to the light path of the laser beam from the laser source, and d spans from a point corresponding to an apex of the first reflective element which is farthest from the second reflective element to a point corresponding to an apex of the second reflective element which is farthest from the first reflective element.

12. The laser device of claim 11, wherein each of the first reflecting element and the second reflecting element is selected from the group consisting of an ellipsoid mirror and a paraboloid mirror.

13. A laser device comprising:
a laser source configured for emitting a laser beam in the TEM_{xy} mode, wherein 0≦x≦3, and 0≦y≦3; and
an optical system disposed on a light path of the laser beam, the optical system comprising at least one optical element comprising a light incident surface and a light emitting surface at opposite sides thereof, the light incident surface facing toward the laser source, at least of the light incident surface and the light emitting surface being a cylindrical-type curved surface for adjusting a field distribution of the laser beam of the laser source.

14. The laser device of claim 13, wherein the cylindrical-type curved surface comprises one of a cylindrical convex surface and a cylindrical concave surface.

15. The laser device of claim 13, wherein the optical system further comprises a first curved reflecting element and a second curved reflecting element both disposed between the laser source and the at least one optical element, and a focal length f₁ of the first reflective element and a focal length f₂ of the second reflective element satisfy the equation:

|f₁|+|f₂|=d
wherein d represents a distance measured parallel to the light path of the laser beam from the laser source, and d spans from a point corresponding to an apex of the first reflective element which is farthest from the second reflective element to a point corresponding to an apex of the second reflective element which is farthest from the first reflective element.

16. The laser device of claim 15, wherein each of the first reflecting element and the second reflecting element is selected from the group consisting of an ellipsoid mirror and a paraboloid mirror.

17. The laser device of claim 13, wherein the optical system further comprises a first curved reflecting element and a second curved reflecting element both disposed on the light path of the laser beam at a side of the at least one optical element farthest from the laser source, and a focal length f₁ of the first reflective element and a focal length f₂ of the second reflective element satisfy the equation:

|f₁|+|f₂|=d
wherein d represents a distance measured parallel to the light path of the laser beam from the laser source, and d spans from a point corresponding to an apex of the first reflective element which is farthest from the second reflective element to a point corresponding to an apex of the second reflective element which is farthest from the first reflective element.

18. The laser device of claim 17, wherein each of the first reflecting element and the second reflecting element is selected from the group consisting of an ellipsoid mirror and a paraboloid mirror.
